(19) United States
(12) Patent Application Publication
(10) Pub. No.: US 2016/0017811 A1
(43) Pub. Date: Jan. 21, 2016

(54) GEARBOX MOUNTING ASSEMBLY

(71) Applicant: UNITED TECHNOLOGIES CORPORATION, Hartford, CT (US)

(72) Inventors: Octavio Martin, Broad Brook, CT (US); Chris J. Niggemeier, Manchester, CT (US)

(21) Appl. No.: 14/771,290

(22) PCT Filed: Feb. 18, 2014
(86) PCT No.: PCT/US2014/016757

§ 371 Date: Aug. 28, 2015

Related U.S. Application Data
(60) Provisional application No. 61/774,658, filed on Mar. 8, 2013.

(51) Int. Cl. F02C 7/32; F02C 3/04

(52) U.S. Cl. CPC F02C 7/32; F02C 3/04; F05D 2220/32; F05D 2260/4031

(57) ABSTRACT

An accessory gearbox mounting assembly includes a gearbox bracket engaged to a case bracket mounted on an engine case. The case bracket includes a first boss receivable within a first cavity of the engine case and a locator opening through the first boss. The gearbox bracket is mountable to a gearbox case and includes a pin receivable within the locator opening for transferring load from the gearbox bracket to the case bracket.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section.

An accessory gearbox is provided to drive pumps, generators and other devices required for operation of the gas turbine engine. Typically a drive shaft from the engine extends into an accessory gearbox mounted to an engine case. Previous mounting structures relied on brackets secured with fasteners such as bolts to secure the gearbox to the engine case. Ultimately the fasteners must withstand loads transmitted from the engine case. According, more and larger fasteners are utilized to accommodate the largest possible loads. Often the size and number of fasteners is greater than is required for most operating conditions. Moreover, more and larger fasteners increase overall weight that may reduce the effectiveness of efficiency gains in other parts of the engine.

Accordingly, it is desirable to design and develop a lighter and smaller gearbox mounting structure that provides the same or better load bearing capabilities.

### SUMMARY

An accessory gearbox mounting assembly according to an exemplary embodiment of this disclosure, among other possible things includes a case bracket including a first boss receivable within a first cavity of an engine case and a locator opening through the first boss. A gearbox bracket includes a second boss mountable within a second cavity defined in a gearbox case. The gearbox bracket includes a pin receivable within the locator opening for transferring load from the gearbox bracket to the case bracket.

In a further embodiment of the foregoing accessory gearbox mounting assembly, a fit of the second boss within the second cavity is an interference fit.

In a further embodiment of any of the foregoing accessory gearbox mounting assemblies, a fit of the first boss within the first cavity is an interference fit.

In a further embodiment of any of the foregoing accessory gearbox mounting assemblies, the locator opening includes a round opening and the pin includes a cylinder receives within the round opening.

In a further embodiment of any of the foregoing accessory gearbox mounting assemblies, the locator opening includes a slot and the pin includes a rectilinear shape corresponding with the slot.

In a further embodiment of any of the foregoing accessory gearbox mounting assemblies, the case bracket includes a flange extending outwardly from the first boss. The flange includes fastener openings for fasteners attached to the engine case. The flange does not transfer load between the gearbox bracket and the case bracket.

In a further embodiment of any of the foregoing accessory gearbox mounting assemblies, includes first and second side links securable between the gearbox case and the engine case for supporting a weight of the accessory gearbox.

In a further embodiment of any of the foregoing accessory gearbox mounting assemblies, includes an axial link securable between the gearbox case and the engine case for transferring an axial load from the gearbox case to the engine case.

A gas turbine engine case configured with an accessory gearbox according to an exemplary embodiment of this disclosure, among other possible things includes a case bracket including a first boss receivable within a first cavity of an engine case and a locator opening through the first boss. A gearbox case supports a drive system for driving a plurality of accessory devices. The gearbox case includes a second cavity. A gearbox bracket includes a second boss received within the second cavity and includes a pin received within the locator opening for transferring load from the gearbox case to the engine case.

In a further embodiment of the foregoing gas turbine engine case, the first boss is an interference fit within the first cavity and the second boss is an interference cavity within the second cavity.

In a further embodiment of any of the foregoing gas turbine engine cases, the locator opening includes a round opening and the pin includes a cylinder received within the round opening.

In a further embodiment of any of the foregoing gas turbine engine cases, the locator opening includes a slot and the pin includes a rectilinear shape corresponding with the slot.

In a further embodiment of any of the foregoing gas turbine engine cases, the case bracket includes a flange extending outwardly from the first boss. The flange includes fastener openings for fasteners attached to the engine case. The flange does not transfer load between the gearbox bracket and the case bracket.

In a further embodiment of any of the foregoing gas turbine engine cases, includes first and second side links securable between the gearbox case and the engine case for supporting a weight of the accessory gearbox.

A gas turbine engine according to an exemplary embodiment of this disclosure, among other possible things includes a core engine section supported within an engine case. A case bracket includes a first boss received within a first cavity on the engine case and a locator opening through the first boss. An accessory gearbox includes a gearbox case supporting a plurality of engine accessory devices. A gearbox bracket includes a second boss received within a second cavity defined on the gearbox case and includes a pin received within the locator opening of the case bracket for transferring load from the gearbox case to the engine case. At least one side link attached to both the accessory gearbox and the engine case for supporting a weight of the accessory gearbox.

In a further embodiment of the foregoing gas turbine engine, the first boss is an interference fit within the first cavity and the second boss is an interference cavity within the second cavity.

In a further embodiment of any of the foregoing gas turbine engines, the case bracket includes a flange extending outwardly from the first boss. The flange includes fastener openings for fasteners attached to the engine case. The flange does not transfer load between the gearbox bracket and the case bracket.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a perspective view of an example gas turbine engine including an accessory gearbox mounted to the engines external case.

FIG. 2 is a perspective view of the example accessory gearbox mounting components.

FIG. 3 is a perspective view of a side link for mounting the accessory gearbox.

FIG. 4 is a cross-section of an example center mount to locate the accessory gearbox on the gas turbine engine case.

FIG. 5 is a perspective view of the example center mount.

FIG. 6 is a cross-sectional view of another example case bracket.

FIG. 7 is a top view of the example case bracket.

FIG. 8 is a cross-sectional view of another gearbox bracket.

FIG. 9 is a top view of the example gearbox bracket.

### DETAILED DESCRIPTION

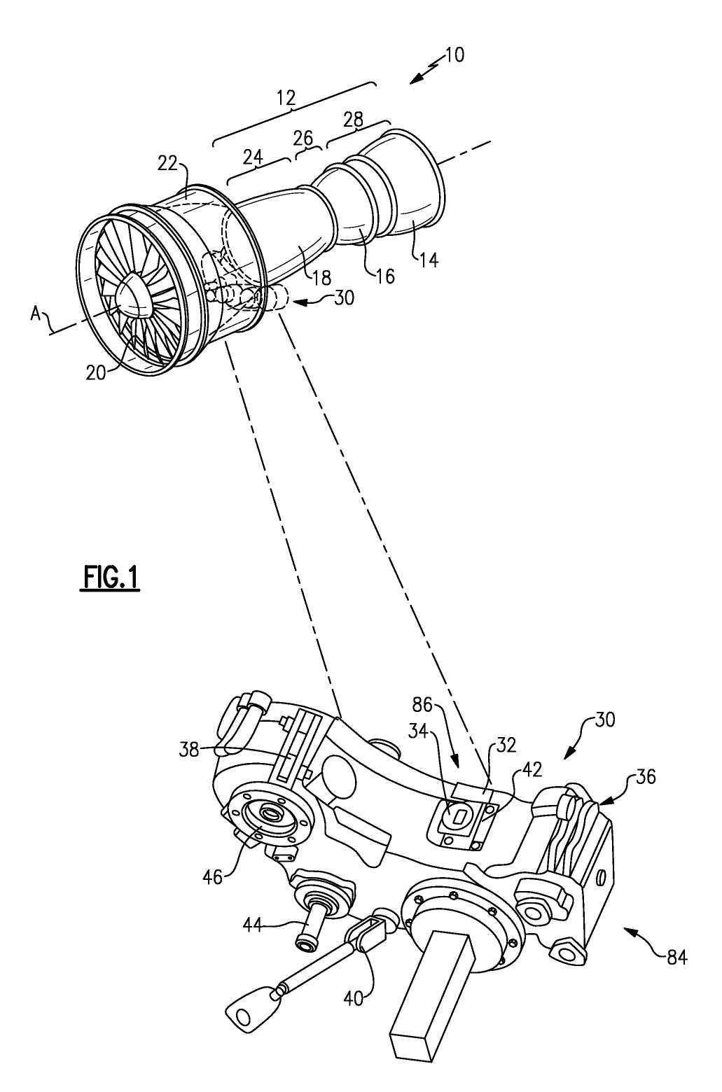

FIG. 1 schematically illustrates an example gas turbine engine 10 that includes a core engine section 12 enclosed within a plurality of connected case structures 14, 16 and 18. The case structures 14, 16 and 18 enclose various core engine sections such as the compressor section 24, the combustor section 26 and the turbine section 28. In this example, the core engine 12 drives a plurality of fan blades 20 of a fan section 22 about an axis A. Accessory components required for operation of a gas turbine engine 10 and other features of an aircraft to which the engine may be mounted is provided by an accessory gearbox 30. In this example, the accessory gearbox 30 is mounted to the engine case 18.

The example accessory gearbox 30 includes a case 32 and is attached to the engine case 18 by a mounting assembly 84. The mounting assembly includes a center mount 86 including a gearbox bracket 42 engaged to a case bracket 34. The case bracket 34 is mounted to the case 18 and mates with the gearbox bracket 42. In FIG. 2, the case bracket 34 is shown mated to the gearbox bracket 42 on the gearbox 30, however, the case bracket 34, in this example, would be attached to the engine case 18.

The mount assembly 84 further includes a first side link 36 and a second side link 38. The side links 36 and 38 attach to the engine case structure 18 on either side of the gearbox bracket 42. An axial bracket 40 is also provided at a forward portion to counter axial load placed on the accessory gearbox 30.

The example accessory gearbox 30 includes various drive features including gearing and other systems that are utilized to drive accessory components, such as an oil pump, fuel pump, generator, and hydraulic pumps as are required for operation of the engine 10. A mount is illustrated at 44 for receiving and driving one of the accessory components. Moreover, the gearbox structure in the case 32 includes specific locations for the mounting of accessory components that are utilized for operation of the gas turbine engine 10.

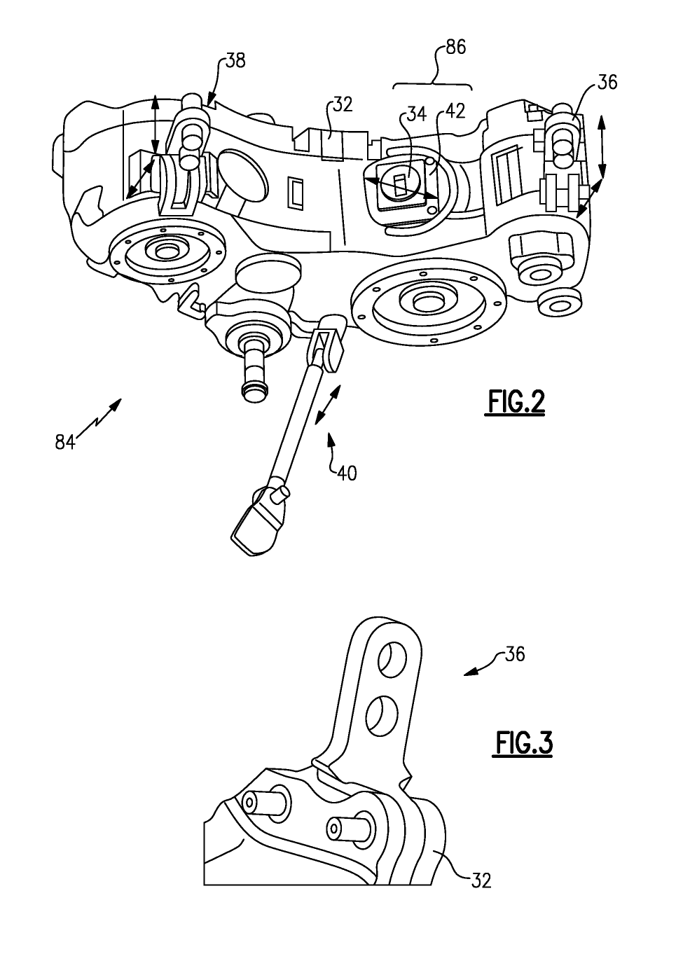

Referring to FIGS. 2 and 3, the example accessory gearbox 30 includes the mount assembly 84 that includes the first side link 36, the second side link 38, the axial bracket 40, as well as the center mount 86 including the case bracket 34 and the gearbox bracket 42. The gearbox bracket 42 is attached to the case 32. In this view, the case bracket 34 is shown, as it would be engaged to the gearbox bracket 42. However, the case bracket 34 is not mechanically fastened to the gearbox bracket 42, and is instead fastened to the engine case 18 at the location where the accessory gearbox 30 is mounted.

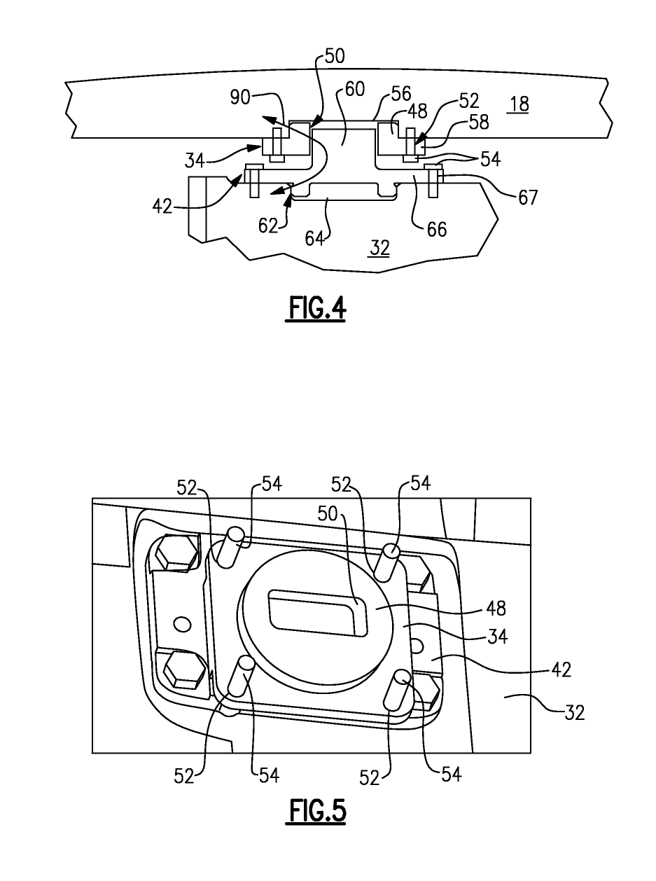

Referring to FIGS. 4 and 5, the example case bracket 34 is received within a first cavity 56 defined within the engine case 18. In this example the accessory gearbox 30 is attached to the engine case 18 near the fan section 22. It should be understood that the accessory gearbox 30 may be mounted to other engine case structures that are within the contemplation of this disclosure.

The case bracket 34 includes a first boss 48 that is received within the cavity 56. The first boss 48 is fit within the cavity 56 in an interference manner. In other words, the outer surface of the first boss 48 engages sidewalls of the cavity 56 as an interference fit. A flange 58 extends from the first boss 48 and includes openings 52 for fasteners 54. The openings 52 for the fasteners 54 provide for the attachment of the case bracket 34 to the engine case 18. However, the fasteners 54 are there to merely maintain a position and orientation of the case bracket 34 and neither encounter nor transfer loads that are transmitted from the accessory gearbox 30. The case bracket 34 includes a locator opening 50 that receives a pin 60 of the gearbox bracket 42.

The gearbox bracket 42 includes a second boss 62 that is received within a second cavity 64 defined within the case 32. The second boss 62 is also disposed within the second cavity 64 in an interference manner. In this way, the fasteners 54 that extend through openings 67 within the flange 66 of the gearbox bracket 42 are provided merely to maintain a position of the gearbox bracket 42 during assembly. Loads indicated at 90 are transmitted between the gearbox case 32 through the second boss 62 and the pin 60 to the case bracket 34. The case bracket in turn transfers loads to the engine case 18 through the interference fit between the first boss 48 and the cavity 56.

The fit between the pin 60 and the locator opening 50 is preferably a tight sliding or non-interference fit. It is desired that there be some minimal clearance to accommodate installation while not being so loose as to prevent transmission of loads.

In this example, the pin 60 and locator opening 50 are corresponding rectilinear shapes. That is, the locator opening 50 forms a slot having a rectangular opening and the pin 60 is rectangular to correspond with the rectangular slot 50. The example orientation the slot 50 includes a long side disposed parallel to the axis A and accommodates some movement in an axial direction while constraining movement transverse to the engine axis A. Moreover, the specific fit between the pin 60 and the locator opening 50 can be provided to define limits of movement between the accessory gearbox 30 and the engine case 18 to accommodate and contain relative movement between the gearbox 30 and case 18.

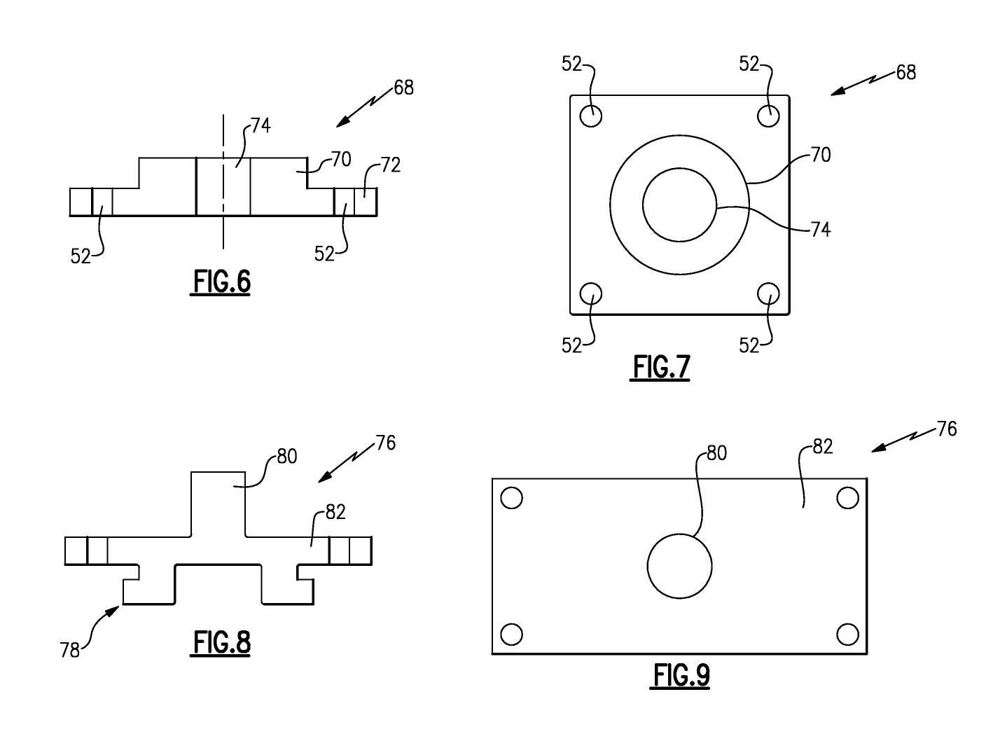

Referring to FIGS. 6, 7, 8 and 9, another example case bracket 68 includes a first boss 70 and a flange 72. The first boss 70 includes a locator opening 74. The locator opening 74 is a round opening and corresponds with a round pin 80 disposed on a corresponding gear bracket 76.

The gear bracket 76 includes the flange 82 that extends from a second boss 78. The second boss 78 of the gear bracket 76 engages the cavity 64 of the gearbox case 32 and the first boss 70 engages the opening 50 of the engine case 18.

In this example, the circular pin 80 is received within the locator opening 74 in a tight slip fit manner and provides for location in both the axial and transverse directions. Moreover, because the fit is between the circular pin 80 within the round opening 74, mating between the case bracket 68 and the gearbox bracket 76 aligns and locates the accessory gearbox 30 relative to the engine case 18 in all directions. Moreover, any clearance that provides for relative movement is uniform about the circular pin 80.

The example center mount 86 toes not transmit load through the fasteners. Instead the fasteners are simply utilized to retain the brackets 34, 42 in place such as during assembly. Transmitting loads independent of the fasteners 54 enables the use of fewer and smaller fasteners, providing a smaller and lighter mounting assembly 84.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An accessory gearbox mounting assembly comprising:
a case bracket including a first boss receivable within a first cavity of an engine case and a locator opening through the first boss; and
a gearbox bracket including a second boss mountable within a second cavity defined in a gearbox case, the gearbox bracket including a pin receivable within the locator opening for transferring load from the gearbox bracket to the case bracket.

2. The accessory gearbox mounting assembly as recited in claim 1, wherein a fit of the second boss within the second cavity is an interference fit.

3. The accessory gearbox mounting assembly as recited in claim 1, wherein a fit of the first boss within the first cavity is an interference fit.

4. The accessory gearbox mounting assembly as recited in claim 1, wherein the locator opening comprises a round opening and the pin comprises a cylinder receives within the round opening.

5. The accessory gearbox mounting assembly as recited in claim 1, wherein the locator opening comprises a slot and the pin comprises a rectilinear shape corresponding with the slot.

6. The accessory gearbox mounting assembly as recited in claim 1, wherein the case bracket includes a flange extending outwardly from the first boss, the flange including fastener openings for fasteners attached to the engine case, wherein the flange does not transfer load between the gearbox bracket and the case bracket.

7. The accessory gearbox mounting assembly as recited in claim 1, including first and second side links securable between the gearbox case and the engine case for supporting a weight of the accessory gearbox.

8. The accessory gearbox mounting assembly as recited in claim 7, including an axial link securable between the gearbox case and the engine case for transferring an axial load from the gearbox case to the engine case.

9. A gas turbine engine case configured with an accessory gearbox comprising:
a case bracket including a first boss receivable within a first cavity of an engine case and a locator opening through the first boss;
a gearbox case supporting a drive system for driving a plurality of accessory devices, the gearbox case including a second cavity;
a gearbox bracket including a second boss received within the second cavity and including a pin received within the locator opening for transferring load from the gearbox case to the engine case.

10. The gas turbine engine case as recited in claim 9, wherein the first boss is an interference fit within the first cavity and the second boss is an interference cavity within the second cavity.

11. The gas turbine engine case as recited in claim 9, wherein the locator opening comprises a round opening and the pin comprises a cylinder received within the round opening.

12. The gas turbine engine case as recited in claim 9, wherein the locator opening comprises a slot and the pin comprises a rectilinear shape corresponding with the slot.

13. The gas turbine engine case as recited in claim 9, wherein the case bracket includes a flange extending outwardly from the first boss, the flange including fastener openings for fasteners attached to the engine case, wherein the flange does not transfer load between the gearbox bracket and the case bracket.

14. The gas turbine engine case as recited in claim 9, including first and second side links securable between the gearbox case and the engine case for supporting a weight of the accessory gearbox.

15. A gas turbine engine comprising:
a core engine section supported within an engine case;
a case bracket including a first boss received within a first cavity on the engine case and a locator opening through the first boss;
an accessory gearbox including a gearbox case supporting a plurality of engine accessory devices;
a gearbox bracket including a second boss received within a second cavity defined on the gearbox case and including a pin received within the locator opening of the case bracket for transferring load from the gearbox case to the engine case; and
at least one side link attached to both the accessory gearbox and the engine case for supporting a weight of the accessory gearbox.

16. The gas turbine engine as recited in claim 15, wherein the first boss is an interference fit within the first cavity and the second boss is an interference cavity within the second cavity.

17. The gas turbine engine as recited in claim 15, wherein the case bracket includes a flange extending outwardly from the first boss, the flange including fastener openings for fasteners attached to the engine case, wherein the flange does not transfer load between the gearbox bracket and the case bracket.
